(19) United States
(12) Patent Application Publication
(10) Pub. No.: US 2012/0047781 A1
(43) Pub. Date: Mar. 1, 2012

(54) MOTORIZED AUTOMATIC SIGN WAVING FIGURE

(76) Inventors: KARL WONDRA, Yuba City, CA (US); ANTHONY OLIVER, Grass Valley, CA (US)

(21) Appl. No.: 13/219,570

(22) Filed: Aug. 26, 2011

Related U.S. Application Data
(60) Provisional application No. 61/377,830, filed on Aug. 27, 2010.

(51) Int. Cl. G09F 19/08

(52) U.S. Cl. 40/411

(57) ABSTRACT

Disclosed is a simulated human form figure, such as a mannequin, which is standing on a wheeled box base, with the hands affixed to a business advertising sign positioned in the direction of passers-by such as on a sidewalk or roadway. The base box contains a battery-operated motor that is connected to the motor mounted in back of the sign so that the arms of the figure will move in a “waving” motion to automatically wave the sign without human intervention.

### CROSS-REFERENCE TO RELATED APPLICATIONS

The present non-provisional application claims credit from the prior U.S. provisional application Ser. No. 61/377,830, filed on Aug. 27, 2010.

### STATEMENT REGARDING FEDERALLY SPONSORED RESEARCH

N/A

### THE NAMES OF THE PARTIES TO A JOINT RESEARCH AGREEMENT

N/A

### INCORPORATION-BY-REFERENCE OF MATERIAL SUBMITTED ON A COMPACT DISC

N/A

### BACKGROUND OF THE INVENTION

(1) Field of the Invention

The invention relates to outdoor advertising, in particular, advertising signs for business. It is well known that a moving sign catches the passer-by's attention more readily than a stationary sign display. The eye is also more readily drawn to the human figure than a stationary frame support.

(2) Description of Related Art including information disclosed under 37 CFR 1.97 and 1.98

### BRIEF SUMMARY OF THE INVENTION

The invention is a human form figure, such as a mannequin, which is standing on a base, with the hands holding a business advertising sign positioned in the direction of passers-by such as on a sidewalk or roadway. The base box contains a battery-operated motor that is connected to the motor mounted in back of the sign so that the arms of the figure will move in a “waving” motion to automatically wave the sign without human intervention.

### BRIEF DESCRIPTION OF THE SEVERAL VIEWS OF THE DRAWING(S)

FIG. 1—a side view of the invention without the sign waving figure

FIG. 2—a side view of the invention with the sign waving figure

### DETAILED DESCRIPTION OF THE INVENTION

Reference Numerals

1—base box which contains the battery relays, fuse, and wiring

2—base wheels are the wheels on all four sides of the base box 1 which both support the base box 1 off the ground surface and afford the invention its mobility to be moved to the desired physical location for sign waving advertising

3—support tube is mounted on the base box 1 which can be comprised of a cylindrical tube, a flat piece of strong material or a four-sided shaft. The support tube 3 is affixed or otherwise connected to the motor support arm 4. The support tube 3 can also provide extra support for the sign waving figure 7

4—motor support arm is affixed or otherwise connected to the top of the support tube 3 and then is bent around the space used by the sign waving figure 7 to where the motor support arm 4 is then connected to the motor and sign support 5

5—motor and sign support contains the sign waving motor and is connected to the motor support arm 4 and the sign support 6

6—sign support is the frame that holds the advertising sign securely while being moved back and forth by the sign waving motor and has two sign waving figure 7 arm connection positions 8 where the simulated arms of the sign waving figure 7 are connected to the sign support 6

7—sign waving figure is the human form figure that simulates movement of the arms or other portions of its human form in order to catch the passers-by's eye with its motion, the sign waving figure 7 arms will at a minimum move from side to side and up and down based on the motor and pulley arrangement incorporated into the motor and sign support 5

8—arm connection positions are where the simulated human sign waving figure 7 has its arms affixed to the sign support 6 probably on either side to show two arms in a familiar human gesture of holding a sign and waving it back and forth or up and down

### DETAILED DESCRIPTION OF THE DRAWINGS

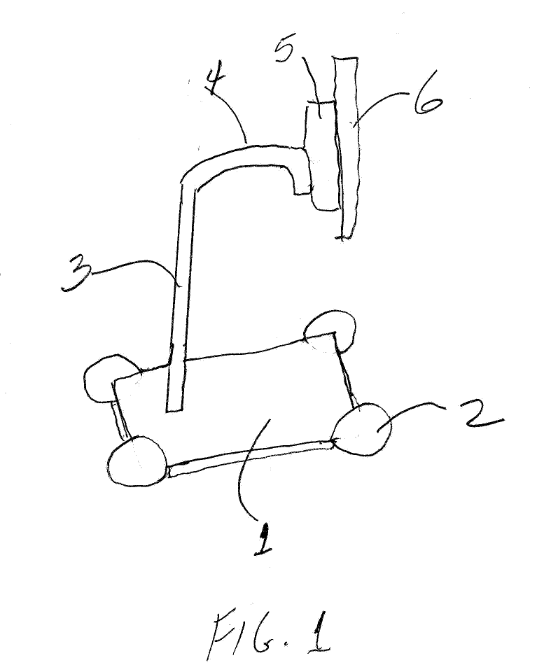

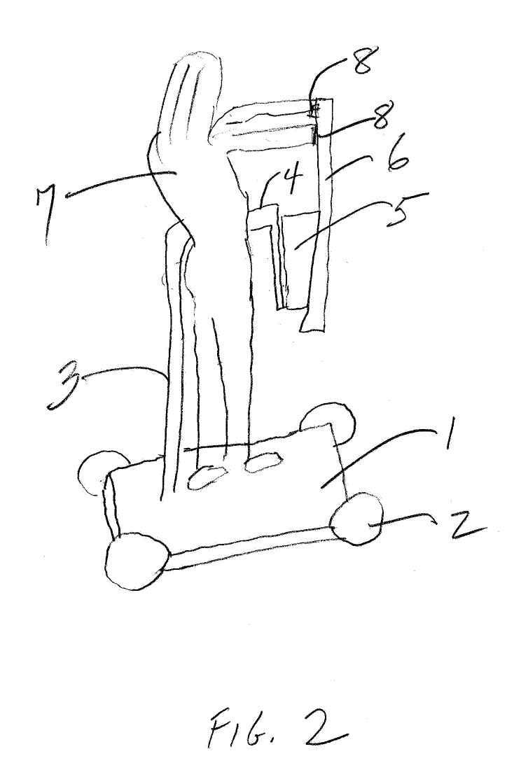

FIG. 1—a side view of the invention without the sign waving figure 7. The base box 1 typically has four base wheels 2, so the base box 1 can be moved conveniently between advertising locations. The base box 1 also has the support tube 2 mounted on the base box 1 which can be comprised of a cylindrical tube, a flat piece of strong material or a four-sided shaft. The support tube 3 is affixed or otherwise connected to the motor support arm 4. The support tube 3 can also provide extra support for the sign waving figure 7 (FIG. 2) contains a battery-operated motor that is connected to the motor and sign support 5 which contains the sign waving motor (not shown) and is connected to the motor support arm 4 and the sign support 6 which is the frame that holds the advertising sign securely while being moved back and forth by the sign waving motor (not shown) and has two sign waving figure 7 (FIG. 2) arm connection positions 8 (FIG. 2) where the simulated arms of the sign waving figure 7 (FIG. 2) are connected to the sign support 6 so that the arms of the figure will move in a “waving” motion to automatically wave the sign without human intervention.

FIG. 2—a side view of the invention with the sign waving figure 7. The base box 1 typically has four base wheels 2, so the base box 1 can be moved conveniently between advertising locations. The base box 1 also has the support tube 2 mounted on the base box 1 which can be comprised of a cylindrical tube, a flat piece of strong material or a four-sided shaft. The support tube 3 is affixed or otherwise connected to the motor support arm 4. The support tube 3 can also provide extra support for the sign waving figure 7. contains a battery-operated motor that is connected to the motor and sign support 5 which contains the sign waving motor (not shown) and is connected to the motor support arm 4 and the sign support 6 which is the frame that holds the advertising sign securely while being moved back and forth by the sign waving motor (not shown) and has two sign waving figure 7 arm connection positions 8 where the simulated arms of the sign waving figure 7 are connected to the sign support 6 so that the arms of the figure will move in a “waving” motion to automatically wave the sign without human intervention.

### DETAILED DESCRIPTION OF THE INVENTION

The present invention relates to an advertising method wherein an automated sign waving figure 7, has its simulated arms connected 8 to the sign waving support 6. The motor that creates the “waving” motion turns a slider that runs on a brass wheel for support.

There is a base box 1 containing the battery relays, fuse, and wiring. The base box 1 has four base wheels 2 or sliding skids so the invention can be conveniently moved. A support tube 3 runs up from the back portion of the base box 1 to where a motor support arm 4 is affixed to the top of the support tube 3, and the motor support arm 4 is then bent or formed around to the front of the invention.

The motor support arm 4 is then connected to the motor and sign support 5, and at this point it holds the motor that is supported on a flat plate, and on the other side of the plate is a round pulley wheel, a flat piece of sheet metal, that has 2 small round metal bars attached to the rear of the plate these run on the pulley and are turned by the motor on the arm. The sign waving figure 7 typically stands on the box and has small balls attached with rope for arms that are then affixed to the arm connection positions on either side of the sign support 6.

The base box 1 is the platform that supports the sign waving figure 7, the support tube 3 is bolted to the base box 1.

The battery (not shown) in the base box 1 provides power through the relay and switch to operate the motor (not shown) that turns a sign to make it look like the sign is moving from side to side. The sign is affixed to the sign support 6 and appears to be held by a sign waving figure that appears to stand on the box.

1. I claim a motorized automatic sign waving machine comprised of:
a base box that is rectangular in shape having wheels at each corner and having a top and a bottom and four sides of sufficient depth to accommodate a battery relays, fuse, and wiring;
an artificial simulated human figure of adult human height in which said artificial simulated human figure's feet are affixed to the base box in front of a support tube, and the simulated arms of said simulated human figure are each affixed to either side of the rear of a support for an advertising sign;
said support tube is almost the height of said simulated human figure having one end of a motor support arm affixed to the top of said support tube and said motor support arm being bent around said simulated human figure to the front of said simulated human figure;
a motor and sign support is affixed to the front portion of said motor support arm and containing a motor and mounts to support the mounting of an advertising sign support; and
an advertising sign support which is mounted on the front of said motor and sign support and on the rear to either side of said advertising sign support are connection means for connecting the simulated arms of said simulated human figure and on the front of said advertising sign support are means to mount an advertising sign.
